(19) United States
(12) Patent Application Publication
(10) Pub. No.: US 2005/0104848 A1
(43) Pub. Date: May 19, 2005

(54) Image processing device and method

(75) Inventors: Osamu Yamaguchi, Kanagawa-ken (JP); Mayumi Yuasa, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 10/949,321

(22) Filed: Sep. 27, 2004

(30) Foreign Application Priority Data
Sep. 25, 2003 (JP) 2003-332816

(51) Int. Cl. G09G 5/00

(52) U.S. Cl. 345/156

(57) ABSTRACT

An image processing device and method automatically enable proper screen display orientation when using a portable device. The image processing device includes an image input unit for acquiring an image of an image of a subject, a face area detector for detecting the face area of the subject in the obtained image, a rotation direction judging unit for judging a relative rotation direction and angle of a face with respect to a device depending on the vertical direction of the detected face area, and a screen controller for rotating an image to be displayed according to the rotation direction of the corresponding image and for displaying the image to be displayed.

### BACKGROUND OF THE INVENTION

1. Field of the Invention

The present invention relates to an image processing device and method of using facial recognition of an object included in a photographic image.

2. Description of the Related Art

Among portable information processing systems including a personal computer with a screen and a function of handwriting recognition, for example, a tablet PC, a PDA (personal digital assistant), a cellular phone, and a portable game machine, some can be used with a display screen in a vertical or a horizontal orientation (description is made by sentences only without drawings). For example, a tablet PC has a function of rotating a screen.

However, in order to rotate such a screen, a user explicitly specifies a rotating direction from a menu, according to a utility program, pushes an operation button, or specifies rotation by a special pen operation, known as a pen action, with a pen-type input function.

A screen typically does not rotate without an input of a rotation-instructive operation as a command and therefore, after freely rotating the screen, it may be necessary to pick it up again in a proper direction or orientation.

More specifically, assuming the case of picking up a device with a screen in an improper direction, the vertical direction of the display on the screen does not agree with the vertical direction of user's view and in order to adjust the direction, a user has to take the trouble to pick up the device again or to instruct rotation of the display on the screen.

In the case of command input to an information processing system through pen action, a user has to write a command correctly on a screen in a direction displayed. For example, with respect to a command for rotating a screen, a user has to move a pen according to the display direction on a screen, and when a screen is rotated, a user has to write a command recognizing a proper orientation according to the relative relationship to the display direction on a screen. Therefore, a user has to take the trouble to consider how to input a command, depending on the status of a screen, thereby resulting in an interface that is not instinctive.

When considering the situation of carrying out television phone or videophone communications by using a camera-equipped mobile device, an image may be upside down or rotated at right angles according to the direction of a camera lens because a sender uses the device holding it in an arbitrary position. In this case, when the image is sent to a receiver as it is, the receiver will have to communicate with the sender viewing the face image rotated horizontally or upside down. Therefore, a sender has to use a phone carefully considering what image will be sent and explicitly set an appropriate command.

A method of controlling a screen of a PC by using a detector of eyes and face direction is known, and this detector is to obtain a face image of a user, detecting a direction of eyes and face, but does not rotate by itself. Therefore, it cannot cope with the user's disadvantage caused by a rotation of a display image (for example, refer to JP-A-8-322796).

### SUMMARY OF THE INVENTION

The invention provides an image processing device comprising an image input unit for acquiring an image of a subject, a face direction detector for detecting the face area of the subject in the obtained image, a rotation direction judging unit for judging a relative rotation direction of a face area with respect to a display of the device based on the vertical direction of the detected face area, and a screen controller for rotating an image to be displayed according to the rotation direction of the corresponding image and displaying it. According to the invention, the screen controller rotates the image to be displayed at least 90° or 180° according to the rotation direction of the corresponding image and displays it.

The invention provides an image processing method comprising an-image input step of acquiring an of a subject, a face direction detecting step of detecting the face area of the subject in the obtained image, a rotation direction judging step of judging a relative rotation direction of a face area with respect to the display of a device based on the vertical direction of the detected face area, and a screen controlling step of rotating an image to be displayed according to the rotation direction of the corresponding image and displaying it. According to the invention, the screen controlling step includes a step of rotating the image to be displayed at least 90° or 180° according to the rotation direction of the corresponding image and displaying it.

The invention provides an image processing device comprising an image input unit for acquiring an image of a subject, a face direction detector for detecting a face area of the subject in the obtained image, a rotation direction judging unit for judging a relative rotation direction of a face area with respect to a display of the device based on the vertical direction of the detected face area, and an image processor for creating an image to be displayed according to the rotation direction of the corresponding image. According to the invention, the image processor rotates the image to be displayed at least 90° or 180° according to the rotation direction of the corresponding image and displays it.

The invention provides an image processing method comprising an image input step of acquiring an image of a subject, a face direction detecting step of detecting the face area of the subject in the obtained image, a rotation direction judging step of judging a relative rotation direction of a face area with respect to a display of the device based on the vertical direction of the detected face area, and an image processing step of creating an image to be displayed according to the rotation direction of the corresponding image. According to the invention, the image processing step includes a step of rotating the image to be displayed at least 90° or 180° according to the rotation direction of the corresponding image and displaying it.

The invention can provide an image processing device and method which a user can use without considering the direction of a screen of the device when using a portable device, by automatically rotating the screen image or processing the input image of a camera for image communication and storage according to the direction of the face of a user using the device. Since the user can use the device at any direction without inputting any complicated command, it can provide a portable information system which enables more instinctive and natural operation.

### BRIEF DESCRIPTION OF THE DRAWINGS

FIGS. 1A and 1B are views showing the structure of a system according to a first embodiment of the invention;

FIGS. 2A and 2B are views showing an example of display when the invention is adopted therein;

FIGS. 3A to 3C are views showing the structure of an image input unit and an example of installing it in a main body;

FIGS. 4A to 4D are views showing positional relationship between the system and an image to be shot;

FIG. 5 is a view showing a flow chart of method A;

FIGS. 6A to 6E are views for use in describing the operational principle of the method A;

FIGS. 7A and 7B are views for explaining the principle of template matching;

FIG. 8 is in view showing a flow chart of a rotation direction judging unit;

FIG. 9 is a view showing a flow chart of a screen controller;

FIG. 10 is a view for explaining the operational principle of a second embodiment of the invention;

FIG. 11 is a view showing the structure of a system according to the second embodiment of the invention; and

FIG. 12 is a view showing a flow chart of the image processor.

### DESCRIPTION OF THE PREFERRED EMBODIMENTS

Hereinafter, preferred embodiments of the invention will be described with reference to the drawings.

### Embodiment 1

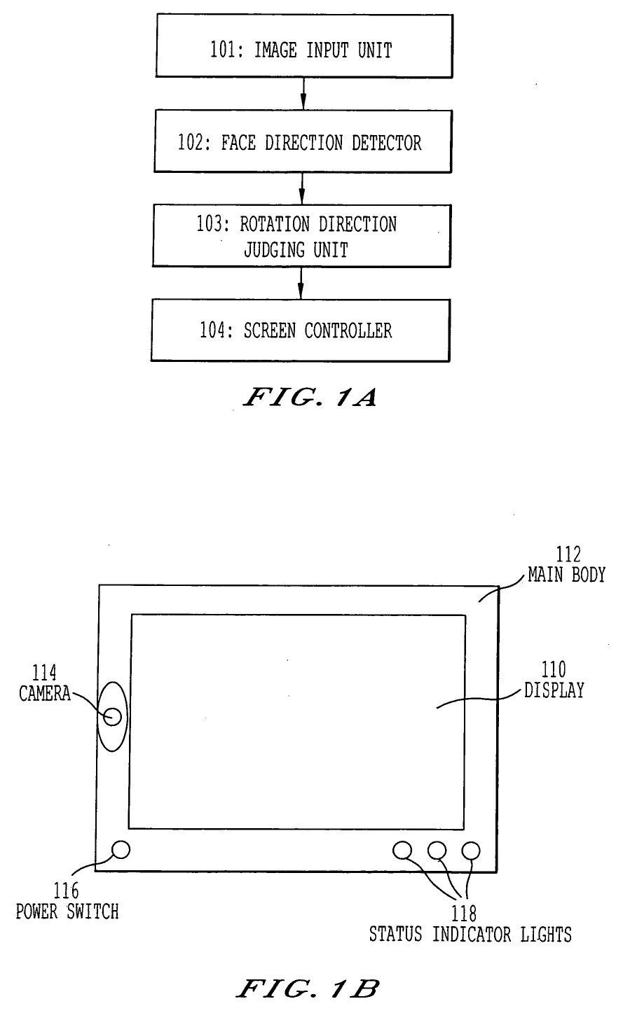

In the embodiment, displaying in the normal direction about the rotation direction of the face to the screen will be described. As an embodiment, a method of realizing the above in a form of a small-sized camera being mounted on a tablet PC will be described. As a constitutional example, a system includes an image input unit 101, a face direction detector 102, a rotation direction judging unit 103, and a screen controller 104, as illustrated in FIG. 1A. An example of the appearance of the system is shown in FIG. 1B. A display 110 is provided on the front surface of the main body 112 of the system and a camera 114, a power switch 116, and status indicator lights 118 are arranged around the display 110.

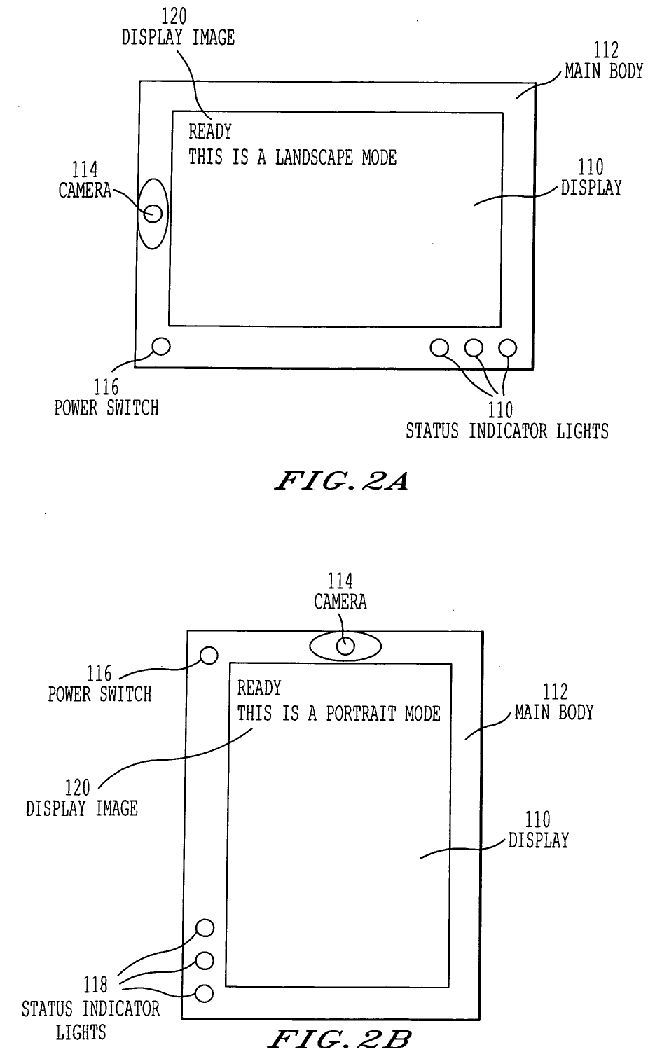

The system can change display according to a relative orientation of the main body with respect to a user (i.e., placing or holding orientation of the display). For example, as illustrated in FIG. 2A, when a camera 114 is horizontally positioned with respect to a user (for example, at a left side on the drawing) or when a side of the whole system having a longest dimension is placed parallel to the ground, a display image 120 is shown on the display 110 in landscape orientation (i.e., landscape display mode). As illustrated in FIG. 2B, when a camera is vertically positioned with respect to a user (for example, at a top side on the drawing) or when a side of the whole system having a shortest dimension is placed parallel to the ground, a display image 120 is shown on the display 110 in portrait orientation (i.e., portrait display mode).

Schematically, an image obtained through a camera is compared with a pre-registered face image template to obtain a face area and the display screen is controlled such that a head direction of the detected user's face area is at the top of the display screen of the system. Hereinafter, the details will be described.

Image Input Unit

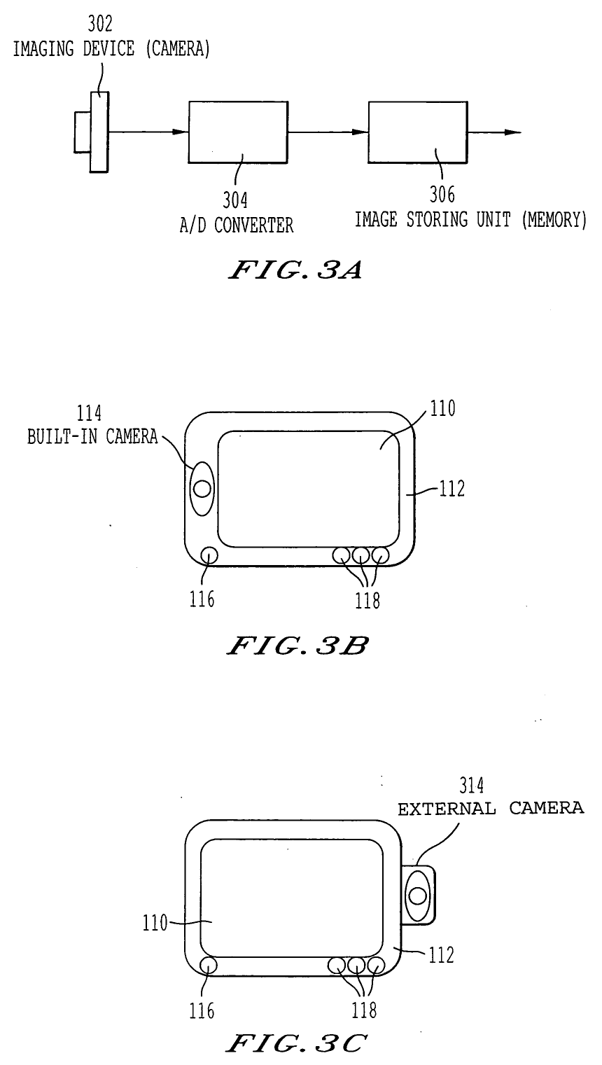

The image input unit 101 is a device for acquiring a face image of a user who uses the system and for inputting the image data into the system. FIG. 3A shows an example in which a man's face image input through an imaging device 302, such as a CCD/CMOS camera, is converted into digital data in an A/D converter 304 and then stored into an image storing unit (memory) 306. The image data stored into the memory 306 is processed by the face direction detector 102 in the posterior stage.

The main body 112 of the system and the image input unit 101 (especially, an imaging device 302) may be integrated (e.g., built-in type camera 114) as illustrated in FIG. 3B, or the image input unit 101 may be externally attached to the main body in a removable way, as an external camera 314 as illustrated in FIG. 3C. In this case, it may be formed as a detachable camera with a USB connection. Resolution of a camera (e.g., the number of pixels) can be properly changed depending on the purpose of a system. Further, the number of image input units is not limited; a single camera may be installed or a plurality of image input units may be provided.

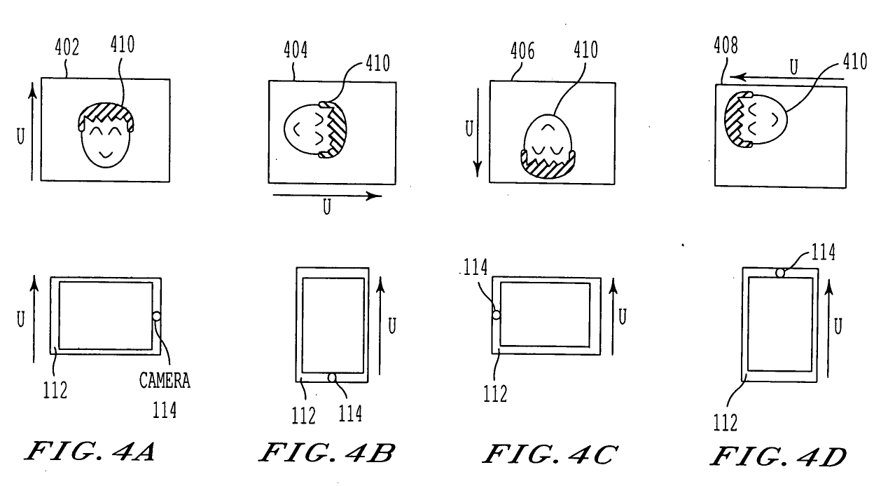

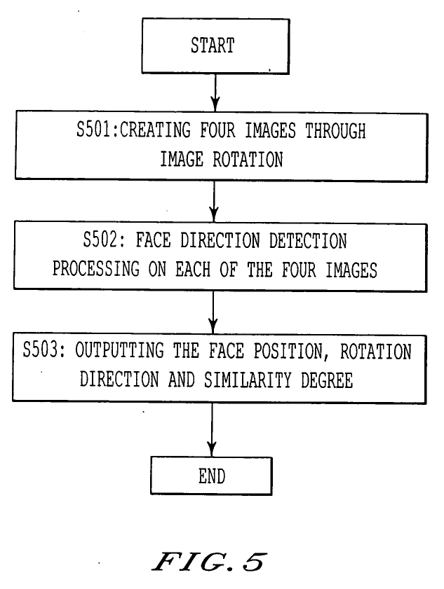

When a user changes the direction of holding the system, the relationship between the direction of the main body toward a user and the image taken by the image input unit will be described by using FIGS. 4A to 4D. FIGS. 4A to 4D schematically show (in the upper portions) images 402, 404, 406, 408 taken depending on the relative position of a portable information system (for example, a tablet PC) shown in the lower portion. Each image 402, 404, 406, 408 includes a face region 410. For example, a camera 114 for acquiring an image 402, 404, 406, 408 mounted on the main body 112 is horizontally positioned in landscape orientation toward a user, which is shown in FIG. 4A. Thus, FIG. 4A shows an example of a condition in which the image 402 is rotated 0° and FIG. 4B shows an example in which the image 404 is rotated 90° (i.e., 90° with respect to the position FIG. 4A in clockwise direction). FIG. 4C shows an example in which the image 406 is rotated 180° (i.e., rotated 180° from position FIG. 4A), when the camera 114 mounted on the main body 112 is horizontally positioned (to the left of a user) in landscape orientation toward a user. FIG. 4D shows an example in which the image 408 is rotated 270° clockwise (or 90° with respect to the position FIG. 4A in counterclockwise direction). Each arrow U is shown near the main body 112 and the images 402, 404, 406, 408 in the drawing for reference. The direction of arrow U indicates the upper direction. Thus, the obtained image is processed depending on the direction of the system main body 112 and the judged orientation of a user's face toward the system, whereby it is enabled to control how to rotate a screen in order to display an image in the normal direction.

Face Direction Detector

The face direction detector 102 performs a face image analysis on the image obtained by the image input unit 101 and to find the orientation and the position of a face area in the image. The facefinding function may be performed by at least two methods, which are roughly distinguished by their face area detecting performance characteristics.

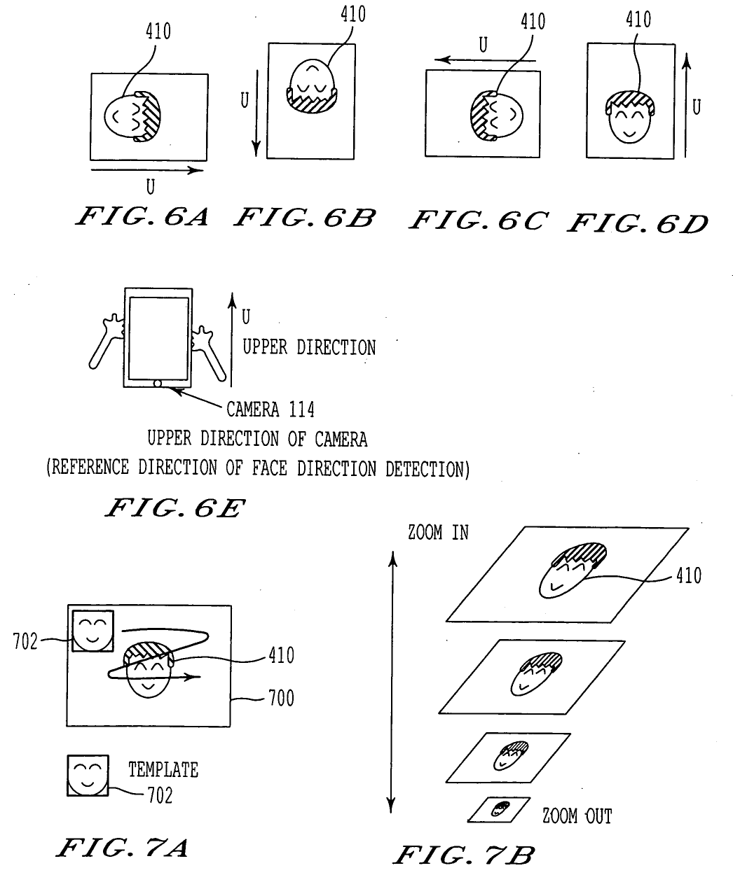

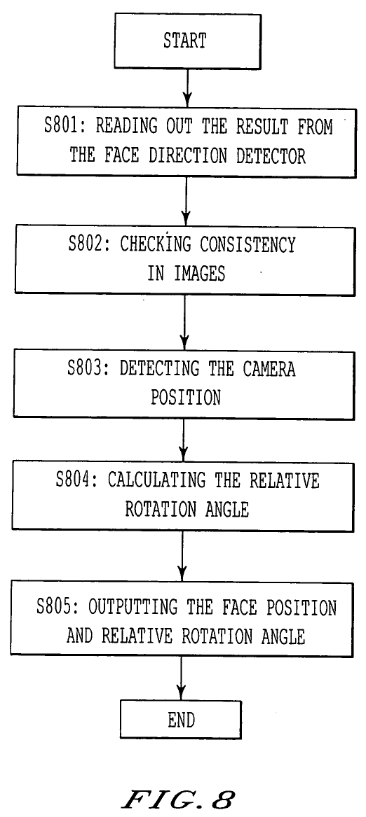

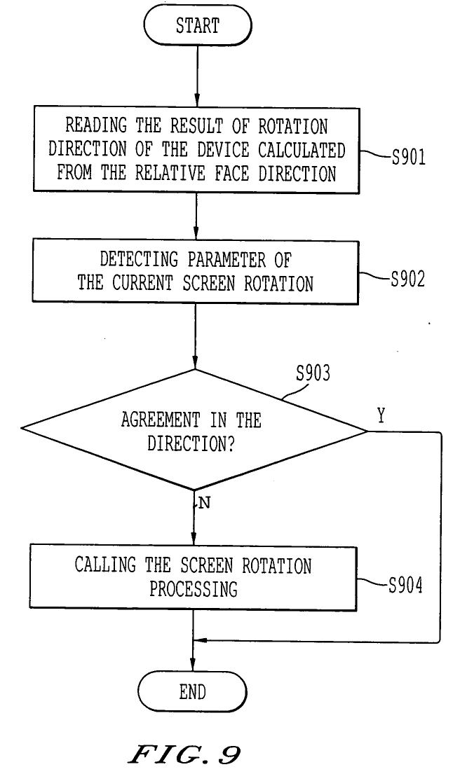

One method, called method A, applies in the case where the face area detecting means itself does not cope with the rotation of image. Namely, taking the images shown in FIGS. 6A to 6D as an example, face detection can be effected on an image captured when a user's orientation toward the system main body indicates a specified direction (for example, an image obtained under the situation corresponding to FIG. 6A) that can be captured by the system. This case generally occurs when a face area can be detected on the face image with a normal position.

The method A includes an algorithm capable of detecting a face area 410 when the face image 410 of normal position has been obtained. In this case, generally a user's orientation toward the main body of the system is not known, and a direction or position of a face in the obtained image is also not known, and therefore, the obtained image is rotated in four possible directions of rotating the face. The method tries thereafter to detect the direction of the face while processing the rotated image.

More specifically, the flow chart shown in FIG. 5 provides an example of method A processing flow. In this example, a plurality of images are created through rotating and turning the obtained image in predetermined directions (refer to S501). For example, at a certain timing, it assumes that in the spatial relationship between the main body system and a user, the short side of the system main body faces a user and the longitudinal sides thereof are positioned in a vertical direction (refer to FIG. 6E). The image obtained in this situation (FIG. 6D) is rotated at three rotation angles (90°, 180°, and 270°), hence to obtain four images in total including the original image (FIGS. 6A, B, C, and D). Template matching processing for detecting face orientation in the respective predetermined directions is performed on these four kinds of images. At this time, it is necessary to set each searching area for template matching corresponding to the respective image areas, as for the images resulting from rotating the input image. For example, since the images of FIG. 6A and FIG. 6C are images in landscape orientation, a searching area in landscape orientation is set. Since the images of FIG. 6B and FIG. 6D are images in portrait orientation, a searching area in portrait orientation is set.

Next, face detecting processing is performed on each image (S502 in FIG. 5). In the detecting method, a template for face detection which is prepared previously is moved within the image, so as to calculate similarity between the template and the image resulting in a position having the highest similarity defined as a face area.

FIG. 7A shows an example of a face direction detection method using template matching in which a template image 702 of fixed size is previously prepared and the obtained image 700 is scanned, hence to calculate similarity between the template image 702 and the image of the scanned area and to specify the area of the image having the highest similarity.

As a calculating method of similarity, a normalized correlation, an Eigenface method, or a subspace method is used to calculate distance and similarity degree between patterns. Any method may be used as the face detecting means for extracting a position having the highest similarity. Templates for faces captured in a plurality of-directions may be prepared and used considering spatial position and angle between a camera for taking a picture and a user. Templates include not only faces obtained in several directions but also other face orientations, for example including templates with a downward face, upward face, slightly-rightward face, and slightly leftward face. Thus, even when obtaining a face image at a position of looking up at a user or even when obtaining a face image in a state where a user does not look toward the front of a camera (for example, in a state where a user slantly looks toward a camera), it is possible to select a template having much higher similarity and to enhance the accuracy of template matching.

Further, a spatial relationship between a user and a camera for acquiring an image differs depending on the using environment. For example, when a user acquires an image of his or her face at a position so close to him or her that the face image extends beyond the imaging area of a camera and the obtained image includes only a part of the user's face, or in other situations where an image of an entire face or head cannot be obtained. Alternatively, when the distance between a camera and a user is large, only a small face image can be obtained and the obtained face image resolution is small with respect to the imaging area of the camera. In such a case, in order to enhance the accuracy of template matching, a pyramid image is created by enlarging or reducing a template image of face area or an input image obtained from a camera and then template matching may be performed thereon, in addition to the above-mentioned method of previously preparing a plurality of face images with each face area different in size.

FIG. 7B shows an example in the case of hierarchically preparing a plurality of images of different resolutions while enlarging or reducing the obtained input image in order to perform the template matching processing. The template matching processing is performed on the input image prepared hierarchically, thereby to enhance the similarity degree with the template image and to improve the accuracy of detecting a face direction even when the size of the face image area in the input image is changed.

As a result of the template matching, information of rotation angle of image, position of the detected face image area within the image, size, and similarity in the matching are supplied as evaluation values (refer to S503 in FIG. 5).

Next, a method B will be described. The face detector of the method B is characterized by using an algorithm capable of detecting a face even when it is rotated. For example, in the article (Henry A. Rowley, Shumeet Baluja, Takeo Kanade: Rotation Invariant Neural Network-Based Face Detection, IEEE Proc. CVPR 1998:38-44), a face area in any rotation direction can be detected by learning the rotated face image and using a plurality of templates. Rotation angle of the obtained image is set not in four directions at every 90° as in the method A, but it may be set at a smaller angle (for example, every 45°, every 30°, every 15°, and every 10°) instead and many rotation images are generated to do the template matching.

When the high performance face detecting function is used, the position of a face area detected in the case of rotating an image and the rotation angle of the image can be calculated and the result is sent to the face rotation direction judging unit. The processing results include face information, including for example the rotation angle of a face, position of a face area, size, and similarity degree in the matching.

(Face) Rotation Direction Judging Unit

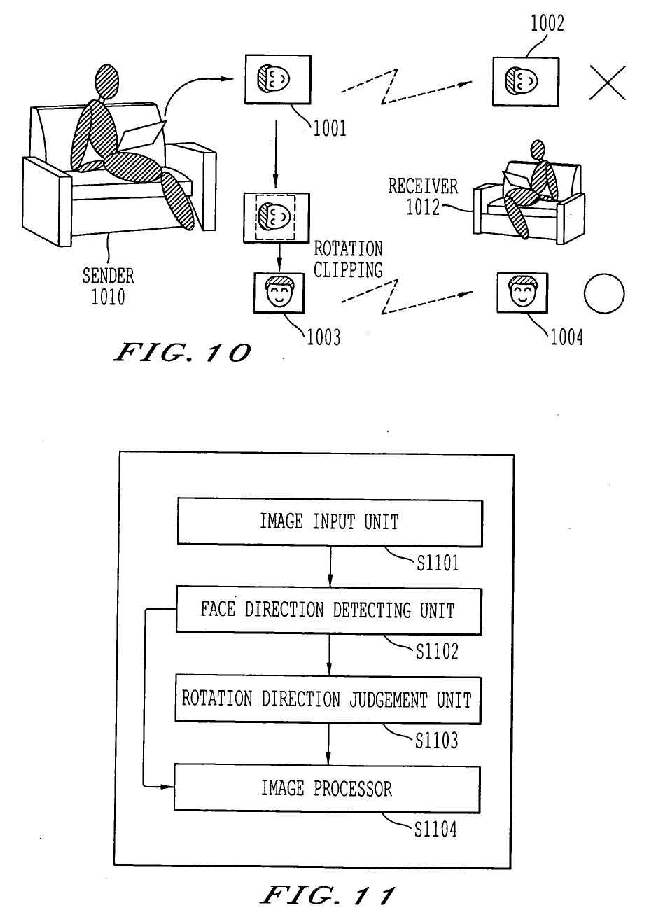

The rotation direction judging unit calculates the rotation direction of a face image of a user relative to the system, considering the position of a camera mounted on the system main body as well as the information on the position and the rotation direction of a face detected by the face detector. FIG. 8 shows an example of the flow of the rotation direction judging unit processing.

In the example of method A shown in FIG. 8, the original input image and three images are obtained by rotating this image at every 90°, resulting in four images that are compared and contrasted with pre-registered face image templates (face direction detecting processing) to obtain the detection results (refer to S801). After obtaining the results, the detection results among the four images are compared with each other and consistency between these images is checked (refer to S802). More specifically, when face direction can be accurately detected, a face area is not detected from three of the four images, but a face area can be detected from the remaining one image which agrees with the stored template image in the face direction. Actually, there may be a problem of producing a bad result that a plurality of face areas are detected at a plurality of positions from one image and that a face area can be detected from each of the other several (rotation) images, because the quality of the, obtained image is not satisfactory or because of a disadvantage of the face direction detecting processing. In this case, similarity degree (similarity with template) accompanying the detection result of each face area is used as a reference and only one face area showing the maximum matching similarity is selected.

The position of the system main body where a camera is mounted is detected and the processing for adjusting the relative position of the camera is performed (refer to S803 and S804). For example, in the case of a camera-built in type, the position of the camera will never change, but in the case of an externally-mounted type with a USB, an image to be taken varies depending on the position of mounting the camera because a PC is provided with a plurality of USB terminals. Accordingly, calculation of the rotation angle relative to the system main body may be varied. Further, in the case of an externally-mounted camera, since there may be a plurality of positions where a camera can be mounted on the main body of the system, it is necessary to change the calculating formula of the relative rotation angle. More specifically, a plurality of calculating formulas and tables are prepared which are previously set depending on the camera's mounted position and some of them can be selected and used.

At last, the relative rotation angle of a face area toward the system main body is calculated from the result of the face direction detecting processing (refer to S805). Namely, of the four images, the rotation angle θ of the image including the face area will be set at one of 0°, 90°, 180°, and 270°. As illustrated in FIG. 3B, taking a camera built-in type as an example, the calculating formula obtained by the above detection results of the camera position is (360−θ)° and according to the calculation expression, the rotation angle of the system can be obtained. After sending the calculated rotation angle of the system to the screen controller, the processing will be finished. Alternatively, orientation (i.e., rotation angle) of the system relative to the rotation angle of a face (i.e., face direction) obtained not from the calculating formula but from the face image may be stored into a table and the rotation angle of the system main body may be calculated corresponding to the rotation angle of a face which agrees with the image.

Next, a possible variation of method B in the face direction detector will be described. In the case of this method, only one image is detected. However, there is a possibility of incorrectly detecting a plurality of face areas in one image or a possibility of detecting a face image in a wrong rotation direction (i.e., face direction) except the four directions because the detection angle (i.e., rotation angle) of a face area can be set more freely at any angle than the four directions.

When a plurality of face areas (i.e., candidates) have been detected in one image by error, only one having the maximum matching similarity is selected from the face area candidates, as in the former method. As for the detection angle of the rotation direction (i.e., face direction), when the detection angle obtained from the image is defined as θB, as shown in the following equation:
θB−α1≦θ≦θB+α2
Where the rotation angle θ is larger than or equal to θB−α1 and smaller than or equal to θB+α2, within a predetermined range and rotation is judged as rotation angle using the equation, where α1 may be equal to α2. In the processing thereafter, the rotation angle of the system is obtained in the same way and the detected angle is sent to the screen controller.
Screen Controller

In the screen controller, based on the obtained rotation angle of the system main body, a display of a screen is rotated according to the relative rotation angle of a face. In the tablet PC of one possible embodiment, a display controller has a function of rotating the screen display and the OS (operating system) provides a library function for controlling the rotation of the whole screen.

The procedure will be described with reference to the exemplary flow chart of FIG. 9. Result of the rotation direction of the system main body calculated from the relative face direction is read out (S901) according to the rotation angle of the system main body obtained by the rotation direction judging unit 103. As for the result of the rotation direction, the parameter of the current screen rotation is detected (S902) and a library function of the OS is called so as to rotate the screen display (S904). As a concrete example, in the case of the latest windows XP operating system, this is realized by setting, for example, the DM_DISPLAYORIENTATION flag and parameter and calling the ChangeDisplaySetting function. In this case, when a screen has been already rotated in the rotation direction (S903, namely when the head portion (i.e., upper direction) of the face image obtained by the face image detection agrees with the upper direction of the screen display contents), a further rotation is not necessary and calling of a function is not necessary, and therefore the rotation direction of the current screen is judged before the rotation processing of the screen display is carried out. Thus, a screen can be automatically rotated from the relative position of a face acquired by a camera without a user's explicit instruction.

### Embodiment 2

In the embodiment 2, a method which enables more natural interactive communication using a communication device, for example a cellular phone or a videophone mounted on a PC. A system according to this embodiment includes a function of generating converted image sequence so as to always show a face image in the normal direction (in a direction of a front face and in the orientation where the visual perception agrees with the screen display in the vertical relationship), without considering the relative rotation direction of a face between the system and a user.

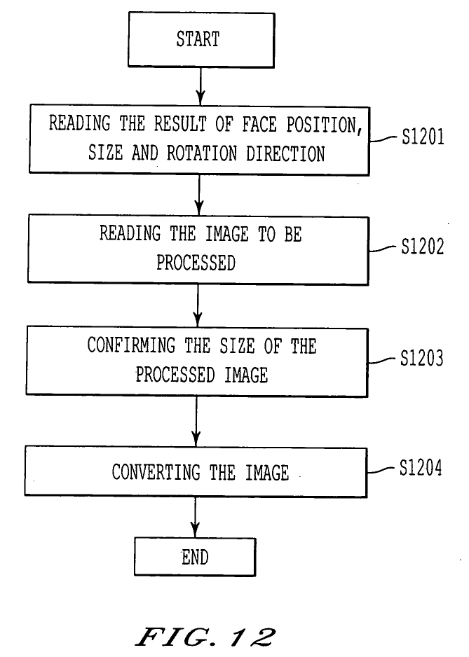

With the function described in the previous embodiment, it is possible to bring the vertical relationship of the image contents into accordance with the vertical relationship of the screen display and to ensure correct screen display, without a user's conscious effort to rotate the main body of the system. In the present embodiment, the scene of carrying out a videophone (for example, an interactive television phone and a TV conference which realizes simultaneous communication of three people or more) is considered and illustrated in the example of FIG. 10. Namely, when a sender 1010 (e.g., one party of the communication) transmits real time video while holding the system main body horizontally in the hand, a camera captures an image of the face horizontally (1001). When the image is transmitted to the other party (e.g., receiver 1012) as it is, the receiving party 1012 is forced to continue the communication with the face oriented horizontally (1002).

Also in this case, on the sending side, a face area of the image is detected and the relative rotation direction of a face toward the system main body is detected, hence to rotate the input image from a camera so as to be in accord with the screen display in the vertical relationship. Then, clipping processing is performed and the image to be transmitted is adjusted according to the aspect ratio and size of the display on the receiving side (1003) before transmission of the image, the vertical relationship on the screen display on the receiving side agrees with the vertical relationship of the image contents, which enables smooth communication through a videophone or a TV conference without imposing a burden on the receiving side (1004).

Also in the case of storing and sending an image taken by a digital (still) camera or a digital video camera, instead of real-time image communication such as a videophone and a TV conference, the direction of a camera is sometimes changed depending on a subject. Also in this case, it is necessary to display and store the rotated image of the shot and by using the same function described above, the image can be rotated on the sending side, to be in accord with the screen display on the receiving side in the vertical relation.

In the above embodiment, with respect to an image taken by the sender, a face area is detected in the image, the face direction, rotation direction, and angle are judged, and the image is rotated on the sending side. Alternatively, the same processing may be performed on the receiving side. More specifically, after the image signal received is decoded and a displayable image is reproduced, the face image detecting processing is performed on the reproduced image, to detect the face direction, specify the vertical relationship of the reproduced image, and rotate the reproduced image so as to be in accord with the image display in the vertical relationship on the receiving side.

FIG. 11 shows an example of the procedural flow of the present embodiment. A captured image is input (S1101), the direction of a face image within the image is detected according to the above-mentioned method (template matching or the like) (S1102), the rotation direction of the image is judged from the vertical relationship of a face area within the image (S1103), and the control of rotating the image is performed so as to be in accord with the image display in the vertical relationship (S1104). When the vertical relationship on the image display and the vertical relationship of the image contents are in agreement, the processing is finished without performing the rotation processing thereon. In order to realize the processing, an image processor S104 is introduced that includes some changes to the screen-controller.

Image Processor

Receiving the position and size of a face area from the rotation direction judging unit, the image processor processes the image so as to orient the face area to the normal position (i.e., upper direction). One possible flow of the processing is shown in FIG. 12. First, the image processor receives face area information, including the position, size, and rotation direction of a face area included in the input image from the rotation direction judging unit (S1201). Then, the image processor reads the image to be rotated (i.e., input image taken by a camera) (S1202). In this case, when a rotated image is already being created by the face direction detector, it may use that rotated image. The image processor reads out the size of the image resultant from the processing depending on the size on the image display and calculates the clipping position of the image and a parameter of geometric transformation (S1203). Based on the calculated parameter, it converts the input image and supplies it to the outside (S1204). The supplied result (e.g., image sequence) is sent to the video communication function and the video storage function.

(Variation)

Although the invention has been described using a tablet PC as an example in the embodiment, it may be adopted to any device capable of freely changing the orientation of its display toward a user, such as a camera-mounted (or a camera externally connectable) personal digital assistant (PDA), a cellular phone, a portable game machine, an electronic book, other portable device capable of image display, or a mobile robot. Further, it is not restricted to the portable information system but may be adopted to a device in a fixed position, like on a desk, for example, a desktop PC and a fixed TV.

Further, it may be provided with a plurality of cameras for acquiring an image. In the case of plural cameras, various variations are possible, including such a variation as using a camera covering a subject in the normal position to recognize the image. As mentioned above, various modifications can be made without departing from the spirit of the invention.

In the embodiments of the invention, it is generally preferred to include each processing function as described above. However, considering the cost of the image processing and the power consumption, processing may be added for reducing the throughput of the image transfer by decreasing the frame rate at which a camera captures an image (e.g., decreasing the number of the shots and increasing the intervals of the shots) and for performing a calculation for face direction recognition only when a system (i.e., camera) moves, while stopping the above processing when a system or a camera does not move, in combination with the operation detection through differential processing which is comparatively lower in calculation cost (i.e., processing amount).

1. An image processing device comprising:
an image input unit configured to obtain an image of a subject;
a face direction detector configured to detect a face area of the subject in the obtained image;
a rotation direction judging unit configured to judge a relative rotation of a face area with respect to a display of the device based on a vertical direction of the detected face area; and
a screen controller configured to rotate an image to be displayed according to the judged relative rotation of the face area in the obtained image and to display the image to be displayed.

2. The image processing device according to claim 1, wherein the screen controller is further configured to rotate the image to be displayed at least 90 degrees.

3. The image processing device according to claim 1, wherein the screen controller is further configured to rotate the image to be displayed at least 180 degrees.

4. The image processing device according to claim 1, wherein the judged relative rotation of the face area with respect to a display of the device includes a rotation angle and a rotation direction.

5. An image processing method comprising:
obtaining an image of a subject;
detecting a face area of the subject in the obtained image;
judging a relative rotation of a face area with respect to a display of the device based on a vertical direction of the detected face area; and
rotating an image to be displayed according to the judged relative rotation of the face area in the obtained image and displaying the image to be displayed.

6. The image processing method according to claim 5, wherein the rotating is further configured to rotate the image to be displayed at least 90 degrees.

7. The image processing method according to claim 5, wherein the rotating is further configured to rotate the image to be displayed at least 180 degrees.

8. The image processing method according to claim 5, wherein the judged relative rotation of the face area with respect to a display of the device includes a rotation angle and a rotation direction.

9. An image processing device comprising:
an image input unit configured to obtain an image of a subject;
a face direction detector configured to detect a face area of the subject in the obtained image;
a rotation direction judging unit configured to judge a relative rotation of a face area with respect to a display of the device based on a vertical direction of the detected face area; and
an image processor configured to create an image to be displayed according to the judged relative rotation of the face area in the obtained image.

10. The image processing device according to claim 9, wherein the image processor is further configured to rotate the image to be displayed at least 90 degrees and to display the image to be displayed.

11. The image processing device according to claim 9, wherein the image processor is further configured to rotate the image to be displayed at least 180 degrees and to display the image to be displayed.

12. The image processing device according to claim 9, wherein the judged relative rotation of the face area with respect to a display of the device includes a rotation angle and a rotation direction.

13. An image processing method comprising:
obtaining an image of a subject;
detecting a face area of the subject in the obtained image;
judging a relative rotation of a face area with respect to a display of the device based on a vertical direction of the detected face area; and
creating an image to be displayed according to the judged relative rotation of the face area in the obtained image and displaying the image to be displayed.

14. The image processing method according to claim 13, wherein the creating further comprises rotating the image to be displayed at least 90 degrees and displaying the image to be displayed.

15. The image processing method according to claim 13, wherein the creating further comprises rotating the image to be displayed at least 180 degrees and displaying the image to be displayed.

16. The image processing method according to claim 13, wherein the judged relative rotation of the face area with respect to a display of the device includes a rotation angle and a rotation direction.
